(19) United States
(12) Patent Application Publication
(10) Pub. No.: US 2014/0317530 A1
(43) Pub. Date: Oct. 23, 2014

(54) METHOD AND DEVICE FOR RECEIVING INPUT

(71) Applicant: Samsung Electronics Co., Ltd., Gyeonggi-do (KR)

(72) Inventors: Deogmoh Chang, Gyeonggi-do (KR); Daehwan Kim, Gyeonggi-do (KR); Youngjoo Lee, Gyeonggi-do (KR); Jaeyun Jung, Gyeonggi-do (KR); Minsuk Choi, Gyeonggi-do (KR); Youngki Hong, Gyeonggi-do (KR)

(73) Assignee: Samsung Electronics Co., Ltd., Gyeonggi-do (KR)

(21) Appl. No.: 14/257,877

(22) Filed: Apr. 21, 2014

(30) Foreign Application Priority Data
Apr. 19, 2013 (KR) 10-2013-0043790

(51) Int. Cl. H04L 29/08

(52) U.S. Cl. CPC H04L 67/10
USPC 715/748

(57) ABSTRACT

A method includes connecting the first electronic device to a second electronic device, determining whether a transfer event occures on a first transfer area of a screen of the first device, transferring the input control authority of the first electronic device to the second electronic device in response to occurrence of the transfer event, and recovering the input control authority of the first electronic device from the second electronic device in response to occurrence of the transfer event on the second device. An electronic device includes a controller configured to transfer the input control authority of the electronic device to the external device in response to occurrence of the transfer event, and recover the input control authority of the electronic device from the external device in response to occurrence of the transfer event on a second transfer area of a second screen of the external device.

### CROSS-REFERENCE TO RELATED APPLICATION AND CLAIM OF PRIORITY

The present application is related to and claims priority from and the benefit under 35 U.S.C. §119(a) of Korean Patent Application No. 10-2013-0043790, filed on Apr. 19, 2013, which is hereby incorporated by reference for all purposes as if fully set forth herein.

### TECHNICAL FIELD

The present disclosure relates generally to an operation of an electronic device, and more particularly to an input control of an electronic device.

### BACKGROUND

In recent years, electronic devices have supported complex operations of various user functions based on the development of hardware technologies. However, a function provided by a conventional electronic device is limited go a function which can be executed only within the corresponding device in many cases.

### SUMMARY

To address the above-discussed deficiencies, it is a primary object to provide an input control method of providing a more improved input control function and an electronic device supporting the same.

In accordance with an aspect of the present disclosure, a method of controlling an input is provided. the method includes connecting the first electronic device to a second electronic device, determining whether a transfer event occures on a first transfer area of a screen of the first device, transferring the input control authority of the first electronic device to the second electronic device in response to occurrence of the transfer event, and recovering the input control authority of the first electronic device from the second electronic device in response to occurrence of the transfer event on a second transfer area of a screen of the second device.

In accordance with another aspect of the present disclosure, an electronic device supporting an input control is provided. The electronic device includes a communication interface configured to connect with an external device to share an input control, a controller configured to determine whether a transfer event occures on a first transfer area of a first screen of the electronic device, transfer the input control authority of the electronic device to the external device in response to occurrence of the transfer event, and recover the input control authority of the electronic device from the external device in response to occurrence of the transfer event on a second transfer area of a second screen of the external device.

In accordance with another aspect of the present disclosure, an electronic device supporting an input control is provided. The electronic device includes a communication module for connecting with another device to share an input control, a control module for, when the communication channel is formed with the another device, receiving an input control authority and allocating a transfer area displaying at least one of an image and a text of an input signal provided by the another device, and a display device for outputting the transfer area and at least one of the image and the text of the input signal.

As described above, the input control method and the electronic device supporting the same according to the present disclosure can support a more improved input control function.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 schematically illustrates a configuration of a device operating system according to the present disclosure;

FIG. 2 illustrates a configuration of a first electronic device according to an embodiment of the present disclosure in more detail;

FIG. 3 illustrates a configuration of a controller of the first electronic device according to an embodiment of the present disclosure in more detail;

FIG. 4 is a flowchart illustrating an operation method of the first electronic device according to an embodiment of the present disclosure;

FIG. 5 is a flowchart illustrating an operation method of the second electronic device according to an embodiment of the present disclosure;

FIG. 6 illustrates a signal flow of a device operating system according to an embodiment of the present disclosure;

FIG. 7 illustrates an example screen interface of a device operating system according to an embodiment of the present disclosure;

FIG. 8 illustrates a signal flow between devices to describe an input control according to a clipboard function according to an embodiment of the present disclosure;

FIG. 9 illustrates an example screen interface which can be applied to the embodiment of FIG. 8;

FIG. 10 is a flowchart illustrating an electronic device operation to describe an input control function according to file transmission according to an embodiment of the present disclosure;

FIG. 11 illustrates an example of a screen interface which can be applied to the embodiment of FIG. 10;

FIG. 12 illustrates a signal flow between devices to describe an input control function according to an execution of a communication App according to an embodiment of the present disclosure;

FIG. 13 illustrates an example of a screen interface which can be applied to the embodiment of FIG. 12;

FIG. 14 is a flowchart illustrating direction processing in an input control function according to an embodiment of the present disclosure; and

FIG. 15 illustrates an example of a screen interface which can be applied to the embodiment of FIG. 14.

### DETAILED DESCRIPTION

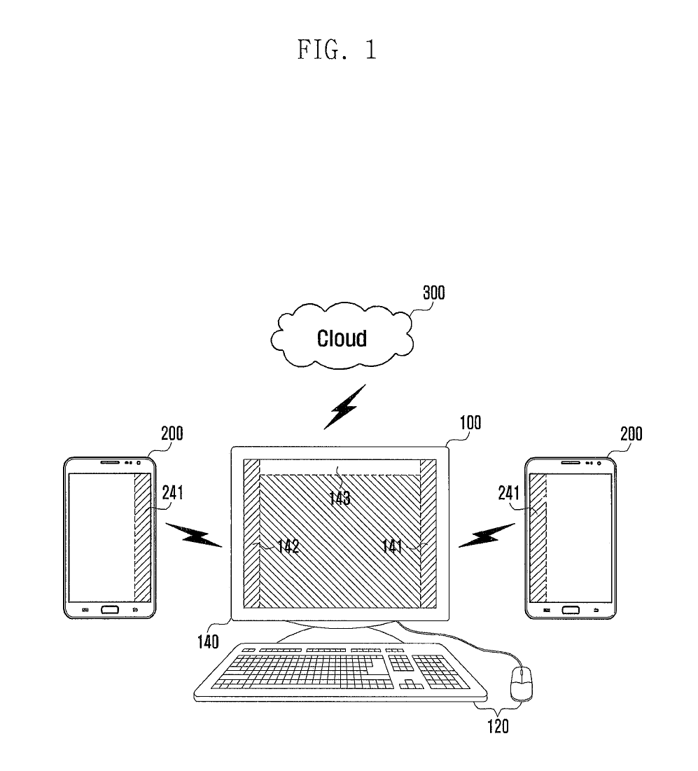

FIGS. 1 through 15, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device. Hereinafter, an embodiment of the present disclosure will be described in detail with reference to the accompanying drawings.

In describing embodiments of the present disclosure, a description will be omitted of the technical contents that are well known in the technical field, to which the present disclosure pertains, and are not directly related to the present disclosure. Also, the descriptions of the component elements that have substantially identical configurations and functions will be omitted.

For the same reason, in the accompanying drawings, some elements may be exaggerated, omitted, or schematically illustrated, and a size of each element may not precisely reflect the actual size thereof. Thus, the present disclosure is not limited by the relative size or interval drawn in the accompanying drawings.

FIG. 1 schematically illustrates a configuration of a device operating system that supports an input control according to an embodiment of the present disclosure.

Referring to FIG. 1, the device operating system according to the present disclosure can include a plurality of electronic devices, for example, a first electronic device 100 and at least one second electronic device 200. Further, the device operating system according to the present disclosure can further include a cloud service device 300 connected to communicate with the first electronic device 100.

The device operating system having the configuration can control a main input unit 120 included in the first electronic device 100 to be operable in the second electronic device. Particularly, when a predetermined condition is satisfied in a state where the first electronic device 100 and the second electronic device 200 form a communication channel, the device operating system can transfer an input control authority of the input unit 120 included in the first electronic device 100 to the second electronic device 200. Further, when a predetermined condition is satisfied, the device operating system can return the input control authority which has been transferred to the second electronic device 200 to the first electronic device 100. Accordingly, the device operating system according to the present disclosure supports more easy operations of various electronic devices by using the main input unit 120 that is more familiar to users or the main input unit 120 that users can more easily access.

The first electronic device 100 can be a device including the main input unit 120. The main input unit 120 can include at least one of various input devices, such as a keyboard, a mouse, and an input pad including a keypad and a drawing pad supporting pen handwriting or drawing input. The main input unit 120 can be connected to the first electronic device 100 through at least one of a cable and a wireless scheme. An input signal generated in the main input unit 120 can be set to be transmitted to the first electronic device 100 by default. An identification of the main input unit 120 can be made while the first electronic device 100 is booted. When the input device is connected to the first electronic device 100 through an access interface during an operation of the first electronic device 100, the first electronic device 100 can recognize the connection and support a port allocation and a buffer allocation for an operation of the corresponding input device. The first electronic device 100 can provide a plurality of transfer areas 141, 142, and 143 to share an input control with one or more electronic devices 200 and 300. In FIG. 1, transfer areas 141 and 142 for sharing an input control with the second electronic devices 200 located at left and right sides and a transfer area 143 for transmitting data to the cloud service device 300 are illustrated. The transfer areas 141 and 142 located at the left and right sides of the first electronic device 100 can be areas for sharing the input control with the second electronic devices 200. The transfer area 143 located at a top side can be a transfer area for transmitting information and for an input control of the cloud service device 300.

The second electronic device 200 can include a communication module which can form a communication channel with the first electronic device 100. Further, the second electronic device 200 can take over an input control authority through the communication channel formed with the first electronic device 100. When the second electronic device 200 takes over the input control authority, the second electronic device 200 can process an input signal generated in the first electronic device 100 equally to an input signal generated in the second electronic device 200. To this end, the second electronic device 200 can perform a mapping operation to make the input signal generated in the main input unit 120 of the first electronic device 100 appropriate for the second electronic device 200. Alternatively, the second electronic device 200 can modify the input signal generated in the main input unit 120 to a form which can be applied to the second electronic device 200. For example, in order to process an input signal provided from a keyboard device included in the main input unit 120, the second electronic device 200 can pre-store information which can recognize codes corresponding to the input signal generated in the corresponding keyboard device. Further, in order to process an input signal provided from a mouse device included in the main input unit 120, the second electronic device 200 can pre-store information which can recognize a mouse movement signal and a mouse button input signal generated in the mouse device. The second electronic device 200 can inform a user of information on recognizable devices among input devices included in the main input unit 120 and also information on non-recognizable devices. When a predetermined condition is satisfied, the second electronic device 200 can return the input control authority received from the first electronic device 100 to the first electronic device 100.

The second electronic device 200 can include a communication module supporting a formation of a communication channel with the first electronic device 100 and a display device outputting a screen according to supporting of an App function to support the input control function according to the present disclosure. Further, the second electronic device 200 can include various input means for generating an input signal, for example, a touch screen, a touch pad, and a physical button. In addition, the second electronic device 200 can include a control module having at least one application processor for processing the input control authority provided by the first electronic device 100 and the input signal.

As described above, the device operating system according to the present disclosure can support such that the main input unit 120 included in the first electronic device 100 can be adaptively used for the operation of the second electronic device 200. In such a process, the device operating system according to the present disclosure can perform various service supports in terms of data transmission between the first electronic device 100 and the second electronic device 200.

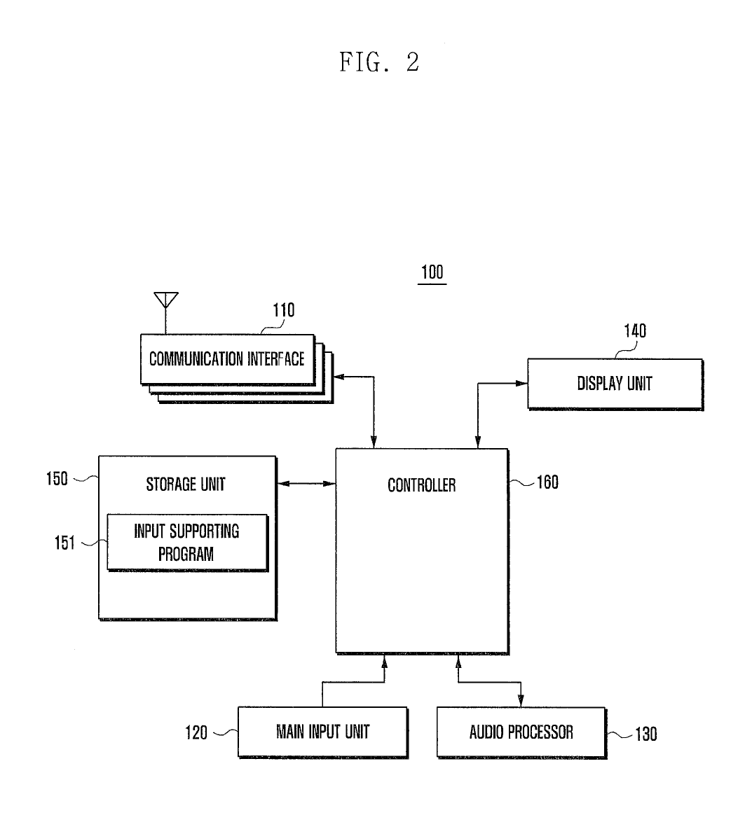

FIG. 2 illustrates the configuration of the first electronic device 100 according to the present disclosure in more detail.

Referring to FIG. 2, the first electronic device 100 according to the present disclosure can include a communication interface 110, an input unit 120, an audio processor 130, a display unit 140, a storage unit 150, and a controller 160.

The communication interface 110 can form a communication channel with one or more second electronic devices 200. The communication interface 110 can support at least one of various communication schemes to form the communication channel with the second electronic device 200. The communication interface can include a communication module in at least one of wired and wireless communication schemes. For example, the communication interface 110 can include at least one of various wired interfaces, such as a Universal Serial Bus (USB) interface, a micro USB interface, and a Universal Asynchronous Receiver Transmitter (UART) interface. Further, the communication interface 110 can include at least one of short-distance communication interfaces, such as a Bluetooth communication interface and a ZigBee communication interface.

Meanwhile, the communication interface 110 according to the present disclosure can be configured by a communication module which can form a communication channel with the cloud service device 300. For example, the communication interface 110 can be configured by a mobile communication module. Further, the communication interface 110 can be configured by an Internet communication module. The communication interface 110 can form a communication channel with at least one of the second electronic device 200 and the cloud service device 300 and transmit the input control authority and the input signal according to a control of the controller 160. Further, the communication interface 110 can transmit particular data, for example, data stored in a clipboard to the second electronic device 200.

The main input unit 120 can generate the input signal according to a user's control and transmit the generated input signal to the first electronic device 100 or transmit the input signal to the second electronic device 200 according to a control of the first electronic device 100. As described above, the main input unit 120 can include various devices, such as the keyboard, the mouse, the touch keypad, the drawing keypad, and a voice recognition based voice input device. The input signal which is transmitted to the first electronic device 100 by the main input unit 120 can include identification information of each input device. For example, the keyboard can transmit a key input signal to the first electronic device 100 based on identification information corresponding to the keyboard input device. Meanwhile, some of a plurality of input devices included in the main input unit 120 can be a device which does not transmit the input control and the input unit according to a characteristic of the second electronic device 200. For example, a voice input device may not transmit a signal to the second electronic device 200 according to whether the second electronic device 200 has an input signal processing function.

The audio processor 130 can process an audio signal of the first electronic device 100. To this end, the audio processor 130 can include at least one speaker. Further, when the first electronic device 100 includes an audio signal collecting function, a microphone is included. The audio signal collected by the audio processor 130 can be provided to the controller 160. The audio processor 130 can support an output of a notification sound for a communication connection state between the first electronic device 100 and the second electronic device 200. Further, when the input control authority of the main input unit 120 is transferred to the second electronic device 200 or the input control authority transferred to the audio processor 130 is returned to the first electronic device 100, the audio processor 130 can support an output of an notification sound thereof. Meanwhile, the audio processor 130 can block an output of an effect sound according to an input signal generated in the main input unit 120 in a state where the input control authority is transferred to the second electronic device 200. Alternatively, the audio processor 130 can output an effect sound according to generation of the input signal based on a user's setting or a designer's intention.

The display unit 140 can support outputs of various screens according to the operation of the first electronic device 100. For example, the display unit 140 can output a booting screen of the first electronic device, a standby screen, menu screen, or icon screen preset according to a completion of the booting. The display unit 140 according to the present disclosure can output a transfer area indicating the transfer of the input control authority. The first electronic device 100 can transfer the input control authority to the second electronic device 200 upon occurrence of a particular event made through a transfer area. For example, the display unit 140 can output a mouse pointer. The mouse pointer can be displayed upon a mouse connection. Further, the mouse pointer can move on the display unit 140 in accordance with a movement of the mouse. At this time, when the mouse pointer enters the transfer area, the first electronic device 100 can determine that an input event for the transfer of the input control authority is occurred. In another example, the mouse pointer moves out beyond the screen area, then the first electronic device 100 can recognize it as the event for the transfer of the input control authority.

Alternatively, the display unit 140 can support a navigation function by a keyboard. For example, the display unit 140 can highlight various displayed objects and indicate a particular object according to a direction input signal or a particular number input signal by the keyboard. During the process, when an input signal indicating the transfer area is generated, the first electronic device 100 can determine that an event for the transfer of the input control authority is generated.

When the transfer of the input control authority is generated, the display unit 140 can output notification information informing that the input control authority of the main input unit 120 is transferred to the first electronic device 100. For example, the display unit 140 can inform of the transfer of the input control authority through a popup window. According to the transfer of the input control authority, the display unit 140 can output a brightness controlled screen or can be turned off. Further, when the input control authority is returned, the display unit 140 can be turned on or can return to an original brightness.

The storage unit 150 is a component for storing various pieces of information related to the operation of the first electronic device 100. For example, the storage unit 150 can store an operating system required for the operation of the first electronic device 100 and application programs related to various user functions. The storage unit 150 can include an input supporting program 151 to support a function of sharing the main input unit 120 according to the present disclosure.

The input supporting program 151 can store various routines for supporting the function of sharing the main input unit 120 according to the present disclosure. For example, the input supporting program 151 can include a routine supporting a display of the transfer area, a routine identifying an event generated in the transfer area, a routine transferring the input control authority to the second electronic device 200 according to the identification of the event, and a routine transmitting an input signal input from the main input unit 120 to the second electronic device 200. The input supporting program 151 can include a routine withdrawing the input control authority from the second electronic device 200 and a routine processing an input signal generated in the main input unit 120 according to the withdrawn input control authority. The input supporting program 151 can include a clipboard routine supporting an operation of a clipboard. The clipboard routine can include a routine transmitting one or more pieces of information stored in the clipboard when the input control authority is transferred and a routine processing the clipboard when the clipboard is received from the second electronic device 200 during a process of withdrawing the input control authority. Further, the input supporting program 151 can include a routine supporting file transmission, a routine processing a message between devices and a routine processing data based on device direction information.

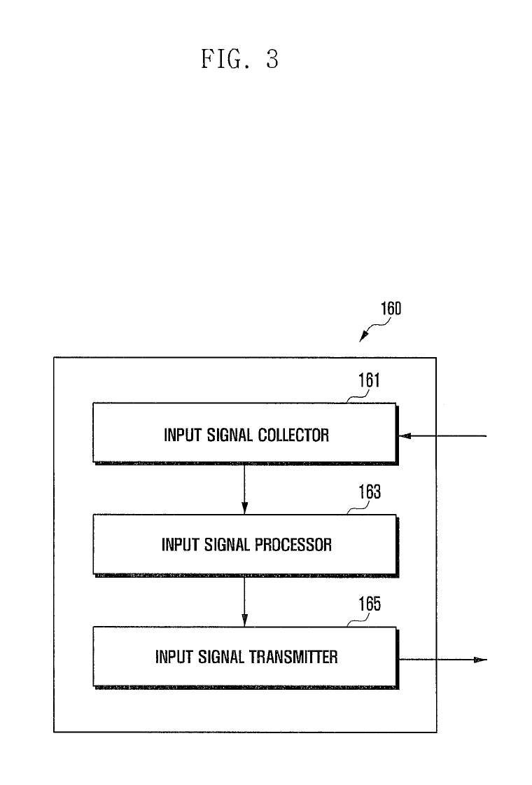

The controller 160 can support processing of various signals and transmission of data for the operation of the first electronic device 100 according to the present disclosure. The controller 160 can support signal processing and data processing for supporting the input control sharing function according to the present disclosure. The controller 160 will be described in more detail with reference to FIG. 3.

FIG. 3 illustrates a configuration of the controller 160 included in the first electronic device 100 according to the present disclosure in more detail.

Referring to FIG. 3, the controller 160 can include an input signal collector 161, an input signal processor 163, and an input signal transmitter 165.

The input signal collector 161 can process an input signal generated in the main input unit 120. For example, the input signal collector 161 can collect various key input signals generated by the keyboard. The input signal collector 161 can collect a movement input signal and a button key input signal generated by the mouse. The input signal collector 161 can collect a voice input. When a drawing pad or a pen supporting pad is separately supported, the input signal collector 161 can collect an input signal generated by the corresponding pad. The input signal collector 161 can identify a position of the input control authority. Further, when the first electronic device 100 has the input control authority, the input signal collector 161 can provide the collected input signal to the input signal processor 163. When the second electronic device 200 has the input control authority, the input signal collector 161 can provide the collected input signal to the input signal transmitter 165.

When a request signal for activating an input control sharing mode according to the present disclosure is generated, the input signal collector 161 can form a communication channel with a neighboring device to be found. To this end, the input signal collector 161 can search for neighbors by using at least one communication interface 110. Then, a communication channel for sharing an input control with a neighboring device, for example, the second electronic device 200 can be formed.

The input signal collector 161 can identify an input signal which can be processed by the second electronic device 200 among input signals provided by the main input unit 120 and provide the input signal which can be processed by the second electronic device 200 to the input signal transmitter 165. When the communication channel is formed with the second electronic device 200, the input signal collector 161 can identify a type of the input signal which can be processed by the second electronic device 200. The input signal collector 161 can receive a list of information on types of signals which can be processed by the second electronic device 200. For example, when the second electronic device 200 cannot process a voice input, the input signal collector 161 can block transmission of a voice input signal. Also, the input signal collector 161 can output notification information informing that the voice input cannot be processed. When the second electronic device 200 cannot process a signal generated by a drawing pad, the input signal collector 161 can block transmission of the corresponding signal.

The input signal collector 161 can support an output of the transfer area. Further, the input signal collector 161 can process the transfer of the input control authority according to an event generated in the transfer area. In addition, when the input signal collector 161 withdraws the input control authority from the second electronic device 200, the input signal collector 161 can support a configuration change according to the withdrawal of the input control authority.

The input signal collector 161 can support collection and transmission of copied data according to an operation of the clipboard. The input signal collector 161 can collect particular file information and provide the corresponding file information to the input signal transmitter 165 according to a file transmission operation. The input signal collector 161 can support reception of message related information and transmission of a written message for an integrated message operation.

The input signal processor 163 can process an input signal provided by the input signal collector 161. The input signal processor 163 can be in an active state or an inactive state according to a position of the input control authority. When the first electronic device 100 has the input control authority, the input signal processor 163 can be activated. Further, the input signal processor 163 can provide a collected input signal to an App currently being operated. The App can perform processing according to the provided input signal.

When the second electronic device 200 has the input control authority, the input signal processor 163 can be deactivated. Further, when the input control authority is withdrawn from the second electronic device 200, the input signal processor 163 can be activated. The input signal processor 163 can have a default active state by a reset of at least one of the first electronic device 100 and the second electronic device 200. For example, when the second electronic device 200 is reset in a state where the second electronic device 200 has the input control authority, the first electronic device 100 can automatically withdraw the input control authority. Alternatively, when the first electronic device 100 is reset, the first electronic device 100 can automatically withdraw the input control authority.

The input signal transmitter 165 can transmit the input signal provided by the input signal collector 161 to the second electronic device 200. The input signal transmitter 165 can be in the inactive state while the first electronic device 100 has the input control authority. The input signal transmitter 165 can be in the active state while the second electronic device 200 has the input control authority. The input signal transmitted by the input signal transmitter 165 can transmit input device type information and corresponding key value information to the second electronic device 200.

Meanwhile, the configuration of the first electronic device 100 can be the same as the configuration of the second electronic device 200 according to a subject to process the input control authority.

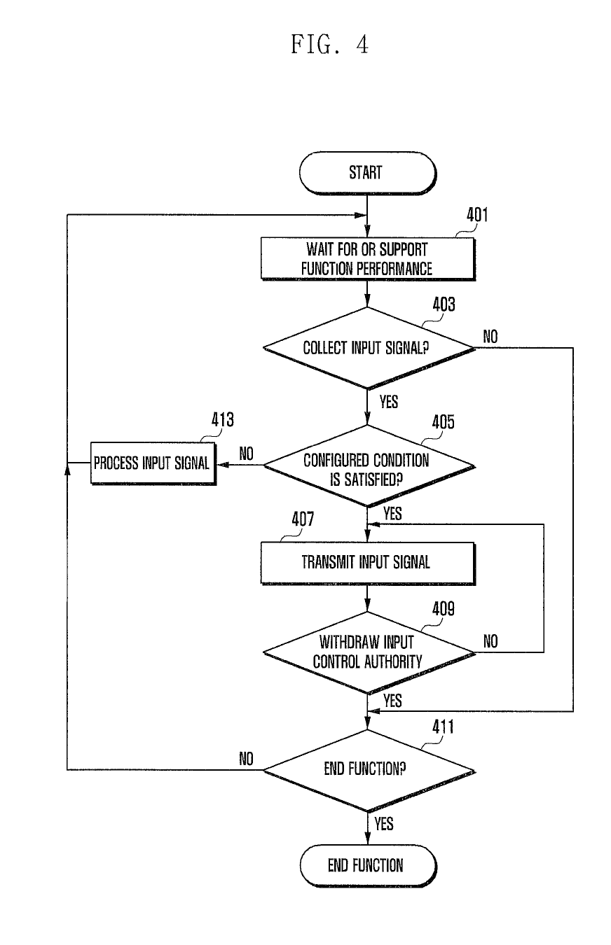

FIG. 4 is a flowchart illustrating an operation of the first electronic device 100 according to the present disclosure.

Referring to FIG. 4, an operation method of the first electronic device 100 according to the present disclosure can wait for function performance or support the function performance in step 401. The controller 160 of the first electronic device 100 can support particular user functions, for example, various functions, such as a file reproduction function, a broadcast reception function, a file editing function, a file search function, and an image collection function in the step of waiting for function performance or supporting the function performance Alternatively, the controller 160 can support an output of an idle screen, a menu screen, or an icon screen, or support a sleep mode state.

Next, the controller 160 can support whether there is collection of an input signal in step 403. When there is no collection of the input signal in step 403, the controller 160 can proceed to step 411 to support a previous state of the first electronic device 100. Meanwhile, when there is the collection of the input signal in step 403, the controller 160 can identify whether a predetermined condition is satisfied in step 405. The predetermined condition can be a condition for calling an input control sharing function. For example, the predetermined configuration can be an occurrence of a predefined input signal or a reception of a predefined gesture input to call the input control sharing function. Further, the predetermined condition can be an occurrence of a particular event in the transfer area on the display unit 140 to call the input control sharing function. In addition, the transfer condition can be formation of a particular predefined communication channel with the second electronic device 200 to automatically share an input control.

When the predetermined configuration is not satisfied in step 405, the controller 160 can process the collected input signal in step 413. For example, when the input signal is generated during performance of the broadcast reception function, the controller 160 can adjust a volume or change a channel according to the corresponding input signal. Further, when the input signal is generated during performance of the file reproduction function, the controller 160 can change the reproduction file or change a file reproduction speed or reproduction format according to the corresponding input signal.

When the predetermined condition is satisfied in step 405, the controller 160 can proceed to step 407 to transmit the input signal to the second electronic device 200. The communication interface 160 can form a communication channel with one or more second electronic devices 200. Further, the controller 160 can transfer the input control authority to the second electronic device 200. Thereafter, the controller 160 can transmit the input signal input in the main input unit 120 to the second electronic device 200.

Next, the controller 160 can identify whether the input control authority is withdrawn in step 409. When the input control authority is not withdrawn, the controller 160 can proceed to step 407 to support re-performance the following steps. That is, the controller 160 can transmit the input signal generated in the main input unit 120 to the second electronic device 200.

When the input control authority is withdrawn in step 409, the controller 160 can support such that the first electronic device 100 processes the input signal generated in the main input unit 120. The withdrawal of the input control authority can correspond to occurrence of a particular event in the transfer area of the second electronic device 200. Alternatively, the withdrawal of the input control authority can correspond to an occurrence of a particular input signal or a reception of a particular gesture input predefined by at least one of the first electronic device 100 and the second electronic device 200. Further, the withdrawal of the input control authority can be performed upon a re-booting or a reset in which at least one of the first electronic device 100 and the second electronic device 200 is turned off and then turned on.

When the withdrawal of the input control authority is generated, the controller 160 can proceed to step 411 to identify whether an input event for ending the function is generated. Further, when the event for ending the function is not generated, the controller 160 can proceed to step 401 and perform the following steps.

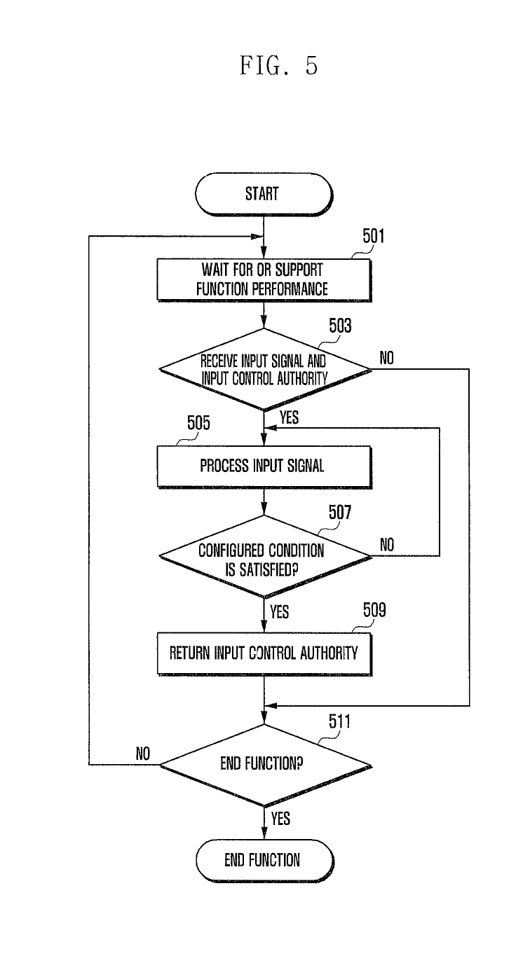

FIG. 5 is a flowchart illustrating an operation of the second electronic device 200 according to the present disclosure.

Referring to FIG. 5, in an operation method of the second electronic device 200 according to the present disclosure, a control module of the second electronic device 200 can wait for function performance or support the function performance in step 501. The waiting for the function performance or the supporting of the function performance in step 501 can be performed equally to step 401 by the second electronic device 200.

Next, the second electronic device 200 can identify whether the second electronic device 200 receives the input control authority and the input signal from the first electronic device 100 in step 503. When there is no reception of the input control authority, the second electronic device 200 can support step 501.

When the second electronic device 200 receives the input control authority and the input signal from the first electronic device 100 in step 503, the second electronic device 200 can proceed to step 505 to support processing of the received input signal. The second electronic device 200 may provide an image effect according to the received input signal. For example, when the second electronic device 200 receives a mouse input signal, the second electronic device may output an image corresponding to a corresponding mouse pointer on the display device. Further, when the second electronic device 200 receives a keyboard input signal, the second electronic device 200 may support a text input/output corresponding to the corresponding keyboard signal. In addition, the second electronic device 200 may support functions according to various embodiments described below.

Next, the second electronic device 200 may identify whether an event satisfying a predetermined condition is generated in step 507. The predetermined condition may be at least one of the conditions which are the same as those for the transfer of the input control authority described in FIG. 4. When the predetermined condition is not satisfied in step 507, the second electronic device 200 may proceed to step 505 to support processing of an input signal received from the first electronic device 100.

When the predetermined condition is satisfied in step 507, the second electronic device 200 may proceed to step 509 to return the input control authority. For example, when a particular event is generated in the transfer area output on the display device, the second electronic device 200 may return the input control authority which has been taken over from the first electronic device 100 to the first electronic device 100. Also, the second electronic device 200 may maintain the input control sharing function by continuously maintaining a communication channel with the first electronic device 100. Alternatively, the second electronic device 200 may release the input control sharing function by removing the communication channel and the transfer area according to a user's configuration or a designer's intention.

Further, the second electronic device 200 may identify whether an event for ending the function is generated in step 511. When the event for ending the function is not generated, the second electronic device 200 may return to step 501 and support re-performance of the following steps. When the event for ending the function is generated, the second electronic device 200 may have a user function end state, for example, a deep sleep state, a turned-off state, or a particular user function end state.

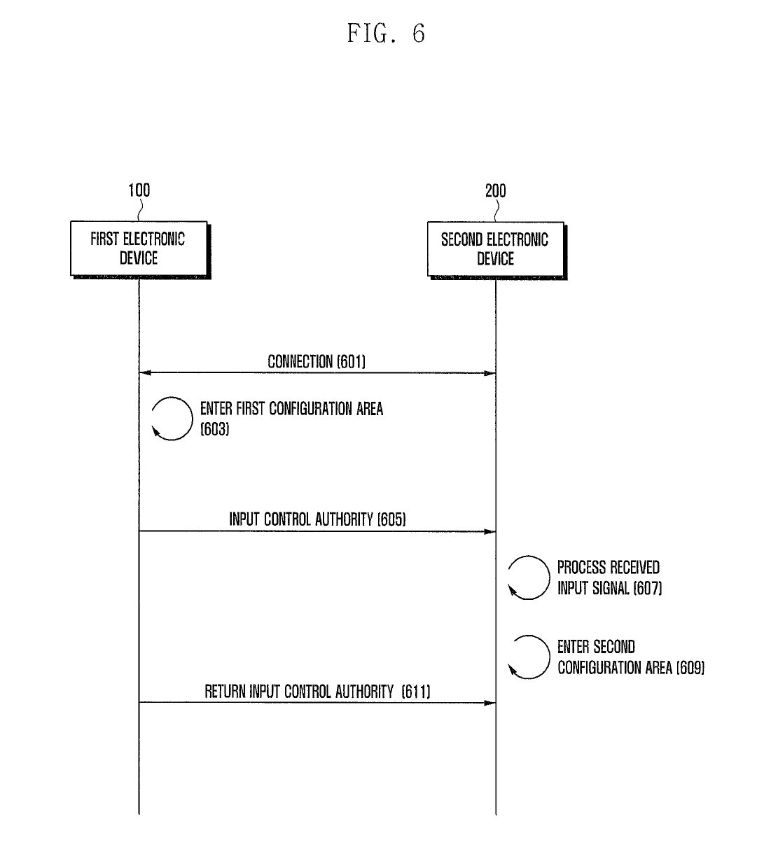

FIG. 6 illustrates a signal flow of a device operating system for sharing an input control according to an embodiment of the present disclosure.

Referring to FIG. 6, the device operating system according to the present disclosure can connect the first electronic device 100 and the second electronic device 200 to support the input control sharing function in step 601. To this end, at least one of the first electronic device 100 and the second electronic device 200 can form a communication channel by using a particular communication interface. For example, the first electronic device 100 and the second electronic device 200 can form a Bluetooth communication channel. Alternatively, a wired connection can be established between the first electronic device 100 and the second electronic device 200. Further, the first electronic device 100 and the second electronic device 200 can activate a particular predefined App for sharing an input control. When the corresponding App is activated, the first electronic device 100 and the second electronic device 200 can execute an input control sharing mode therebetween. Further, the first electronic device 100 and the second electronic device 200 can output transfer areas for the transfer of the input control authority on the display unit and the display device, respectively.

Next, when a particular event is generated in a first transfer area output on the display unit 140 in step 603, for example, when a mouse pointer enters a first transfer area, the first electronic device 100 can transfer the input control authority to the second electronic device 200 in step 605. Thereafter, the first electronic device 100 can provide the input signal generated in the main input unit 120 to the second electronic device 200.

When the second electronic device 200 takes over the input control authority from the first electronic device 100, the second electronic device 200 can process the received input signal provided by the first electronic device 100 in step 607. The received input signal can vary depending on a type of App which is being executed in the second electronic device 200. Meanwhile, when a particular event is generated in a second transfer area output on the display device in step 609, the second electronic device can provide the input control authority to the first electronic device 100 in step 611. For example, the second electronic device 200 can receive a movement signal of the mouse pointer from the first electronic device 100. Then, the second electronic device 200 can output an image for the mouse pointer and display the corresponding mouse pointer image on the display device according to the movement signal. Further, when the mouse pointer enters the second transfer area, the second electronic device 200 can determine it as the withdrawal of the input control authority and return the input control authority in step 611. Meanwhile, the device operating system can differently operate the transfer and the withdrawal of the input control signal according to various configuration conditions.

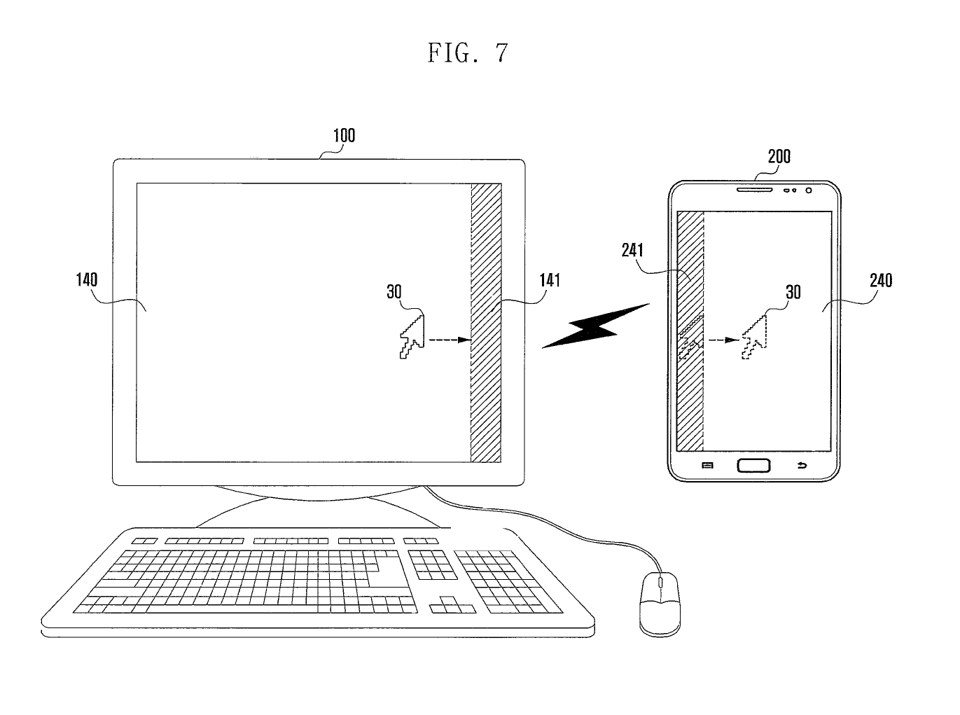

FIG. 7 illustrates an example of a screen interface which can be provided by the device operating system according to the present disclosure.

Referring to FIG. 7, in the device operating system according to the present disclosure, the first electronic device 100 and the second electronic device 200 can form a communication channel through at least one of particular predefined communication schemes to support the input control sharing function. Further, the first electronic device 100 and the second electronic device 200 can activate a particular App for supporting the input control sharing function. Alternatively, according to the activation of the App for the input control sharing function installed in at least one of the first electronic device 100 and the second electronic device 200, the first electronic device 100 and the second electronic device 200 can form the communication channel.

In the device operating system according to the present disclosure, when the input control sharing mode is activated, the first electronic device 100 can output a first transfer area 141 on the display unit 140. The second electronic device 200 can output a second transfer area on the display device 240. Although FIG. 7 illustrates that the first transfer area 141 and the second transfer area 241 have a predetermined shade in the display unit 140 and the display device 240, respectively, the present disclosure is not limited thereto. That is, the first transfer area 141 and the second transfer area 241 can be shaded as described above, but the transfer area 141 and the second transfer area 241 can be processed to be transparent. Further, the display unit 140 and the display device 240 can output notification information of the first transfer area 141 and the second transfer area 241, for example, text information such as the transfer of the input control authority or predefined particular image information, respectively.

In connection with the transfer of the input control authority, for example, a mouse pointer 30 corresponding to a mouse input device can be output on the display unit 140. When the user moves the mouse pointer 30 to the first transfer area 141, the first electronic device 100 can transfer the input control authority to the second electronic device 200 and also transmit information related to the mouse pointer 30 to the second electronic device 200. When the second electronic device 200 receives the input control authority and the information related to the mouse pointer 30, the second electronic device 200 can preferentially display the mouse pointer 30 in the second transfer area 241 and move the mouse pointer 30 according to the information related to the mouse pointer 30. In the input control sharing mode, the first electronic device 100 and the second electronic device 200 can map the first transfer area 141 and the second transfer area 241. Accordingly, when the mouse pointer 30 enters a particular part of the first transfer area 141, the mouse pointer 30 can be output from a particular part of the second transfer area 241. For example, when the mouse pointer 30 enters a center part of the first transfer area 141, the mouse pointer 30 can be removed from the display unit 140 after a predetermined time elapses. Further, the mouse pointer 30 can be output on the second transfer area 241 of the display device 240. Particularly, the mouse pointer 30 can be output on the center part of the second transfer area 241. According to the movement of the mouse, the mouse pointer 30 can be moved and displayed on the display device 240. When the mouse pointer 30 enters an upper part of the first transfer area 141, the corresponding mouse pointer 30 can be output on an upper part of the second transfer area 241.

The second electronic device 200 can control a function according to the provided mouse pointer 30. For example, when the mouse pointer 30 is overlappingly placed on a particular icon displayed on the display device 240, the second electronic device 200 can highlight the corresponding icon. Further, when an input signal corresponding to a left click of the mouse device is transmitted to the second electronic device 200, the second electronic device 200 can process the input signal to select the highlighted icon.

In a state where the first electronic device 100 and the second electronic device 200 share the same screen through a screen interface according to the present disclosure or a state where the devices are executing Apps, respectively, a more convenient input control can be made. For example, when the screen is shared, the device operating system according to the present disclosure can support such that the second electronic device 200 continuously performs the input signal processing performed by the first electronic device 100. Further, even when the screen is not shared, for example, when the first electronic device executes a first App and the second electronic device executes a second App, an input control of the second App can be more rapidly and conveniently made as necessary during a process of performing an input control for the execution of the first App. In the screen sharing process, displayed screen ratios may be changed in consideration of display device ratios of the first electronic device 100 and the second electronic device 200.

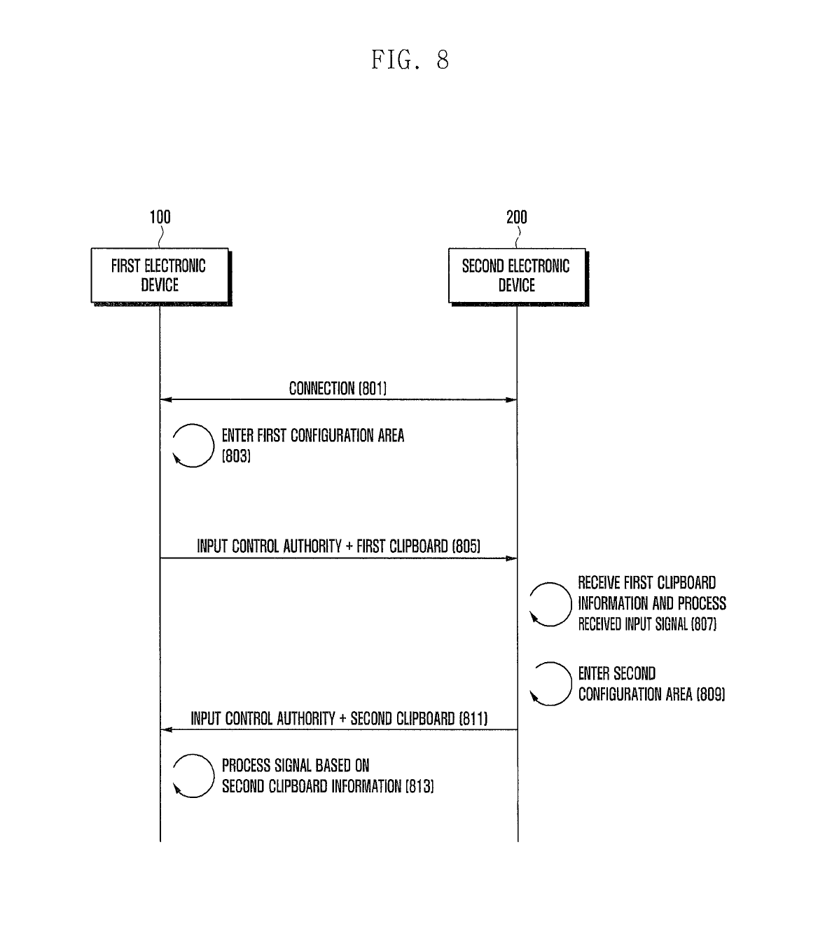

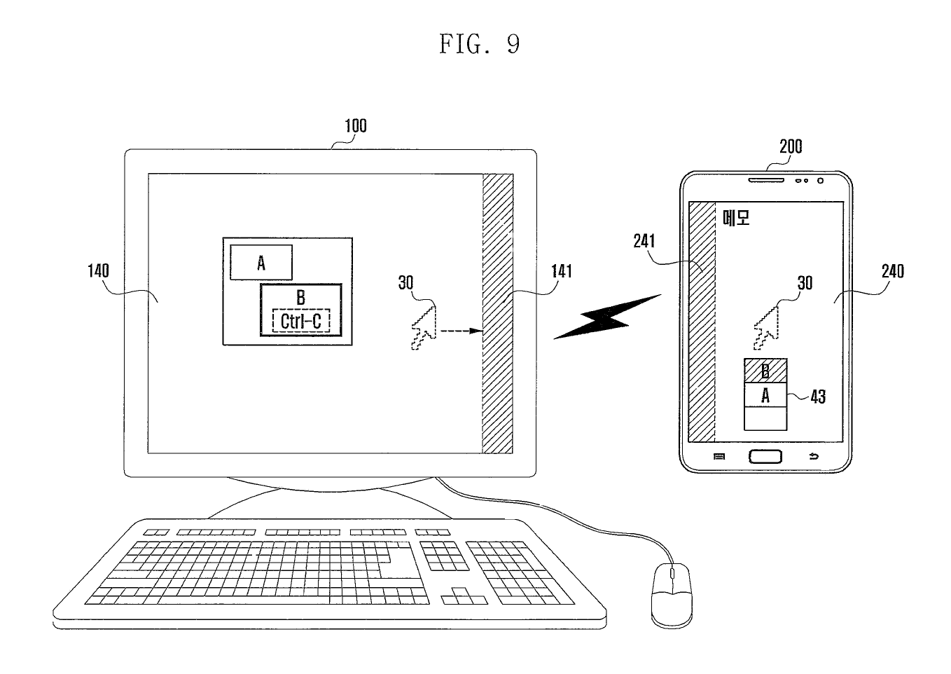

FIG. 8 illustrates a signal flow in the device operating system supporting a clipboard related input control sharing function according to an embodiment of the present disclosure and FIG. 9 illustrates an example of a screen interface which can be operated in the input control sharing function of FIG. 8.

First, referring to FIG. 8, the first electronic device 100 and the second electronic device 200 can perform a connection operation to support the clipboard related input control sharing function according to the present disclosure in step 801. To this end, at least one of the first electronic device 100 and the second electronic device 200 can form a communication channel by using a particular communication interface and then activate an App for supporting the input control sharing function. Alternatively, according to the activation of the App, at least one of the first electronic device 100 and the second electronic device 200 can form the communication channel therebetween.

Meanwhile, the first electronic device 100 can store at least one of a particular document, image, and audio file in a first clipboard according to an App which is being executed according to a user input control. To this end, the first electronic device 100 can activate an App requiring an execution of the clipboard, and register and store copy requested information in the first clipboard according to the execution of the corresponding App. The user can reproduce a particular document and content and generate an input signal for selecting a partial area to be copied, from the corresponding document or content, in the first clipboard by using the main input unit 120 while operating the first electronic device 100. Then, the first electronic device 100 can store at least one of a part or all of a document selected by the user, a part or all of a particular image, and a part or all of a particular audio file in the first clipboard according to a user's designation. At this time, the first electronic device 100 can store only content most recently designated to be copied in the first clipboard. Alternatively, the first electronic device 100 can sequentially store some of a plurality of designated contents designated to be copied in the first clipboard.

The mouse pointer operated by the mouse device of the first electronic device 100 can enter the first transfer area in step 803. Then, the first electronic device 100 can transmit the input control authority and the first clipboard to the second electronic device 200 in step 805. At this time, the first electronic device 100 can also provide information related to the mouse pointer to the second electronic device 200. The information related to the mouse pointer can include a current position and movement information of the mouse pointer. Further, the information related to the mouse pointer can include information on a right click, a left click, or a wheel of the mouse.

Next, the second electronic device 200 can receive first clipboard information and process the received input signal in step 807. That is, the second electronic device 200 can support an output of the mouse pointer and an operation of the first clipboard. More specifically, when the second electronic device 200 receives a particular input signal in a part indicated by the mouse pointer, for example, an input signal of a mouse left click or a mouse right click from the first electronic device 100, the second electronic device 200 can control to copy information stored in the first clipboard in the area indicated by the mouse pointer. At this time, when a plurality of pieces of information are stored in the first clipboard, the second electronic device 200 can control to preferentially copy most recently stored information. Alternatively, the second electronic device 200 can provide a list of all pieces of information stored in the first clipboard to allow the user to select information.

Meanwhile, after step 807, the second electronic device 200 can process the input signal generated and provided by the main input unit 120 of the first electronic device 100. In such a process, the second electronic device 200 can collect information requested to be stored in the clipboard among contents stored in the second electronic device 200 or output on the display device 240 as second clipboard information according to a user's control.

Further, when the mouse pointer generated by the input signal provided by the first electronic device 100 enters the second transfer area of the display device 240 in step 809, the second electronic device 200 can transmit the second clipboard information to the first electronic device 100 together with returning the input control authority in step 811. The second clipboard information can be information stored in the clipboard in the second electronic device 200 after the transfer of the input control authority.

Referring to FIG. 9, the first electronic device 100 and the second electronic device 200 can establish a connection for executing the input control sharing function according to the present disclosure, and accordingly, can configure the first transfer area 141 and the second transfer area 241 on one side of the screen as illustrated in FIG. 9. The first transfer area 141 and second transfer area 241 can be an area of the display unit 140 of the first electronic device 100 and an area of the display device 240 of the second electronic device 140 which are close to each other. The designation of positions of the first transfer area 141 and the second transfer area 241 can be changed according to a user's control. The first transfer area 141 and the second transfer area 241 can be designated as predetermined areas by default and then changed according to a user's control.

The first electronic device 100 can output one or more contents according to an App execution. In FIG. 9, two contents A and B are output. The user can select and copy each of the contents A and B and store the contents A and B in the first clipboard. At this time, it is assumed that the user lastly copies the content B. The contents A and B can be at least one of a text content, an image content, and an audio content.

Meanwhile, the user can move the mouse pointer 30 displayed on the display unit 140 to the first transfer area 141 by controlling the mouse. When the mouse pointer 30 enters the first transfer area 141, the first electronic device 100 can determine that an event instructing to transfer the input control authority to the second electronic device 200 is generated. The first electronic device 100 can transmit information related to the mouse pointer 30 to the second electronic device 200 while transferring the input control authority to the second electronic device 200. At this time, the first electronic device 100 can also transmit first clipboard information to the second electronic device 200.

When the mouse pointer 30 enters the first transfer area 141, the mouse pointer 30 can disappear from the display unit 140 and can be displayed on the second transfer area 241. The mouse pointer 30 can be moved and displayed on the display device 240 according to an operation of the mouse device. The user can perform an input action for copying information in a particular area displayed on the display device 240, for example, a keyboard control or a mouse control. When the second electronic device 200 receives an input signal according to the corresponding input action from the first electronic device 100, the second electronic device 200 can copy information stored in the first clipboard. At this time, the second electronic device 200 can preferentially display a list 41 of pieces of information included in the first clipboard on the display device 240 and copy information selected by the user. Alternatively, the second electronic device 200 can control to copy most recently stored information among the information included in the first clipboard without any display of the list 43.

Meanwhile, when the mouse pointer 30 including the first clipboard is moved to the second electronic device 200, the second electronic device 200 can support to display the list 43 including information on contents to be copied on an area adjacent to the mouse pointer 30. Alternatively, the second electronic device 200 can support to display information on at least some of most recently copied contents, for example, content title information or a part of the content of the contents on an area adjacent to the mouse pointer 30, in a form of at least one of a text or an image.

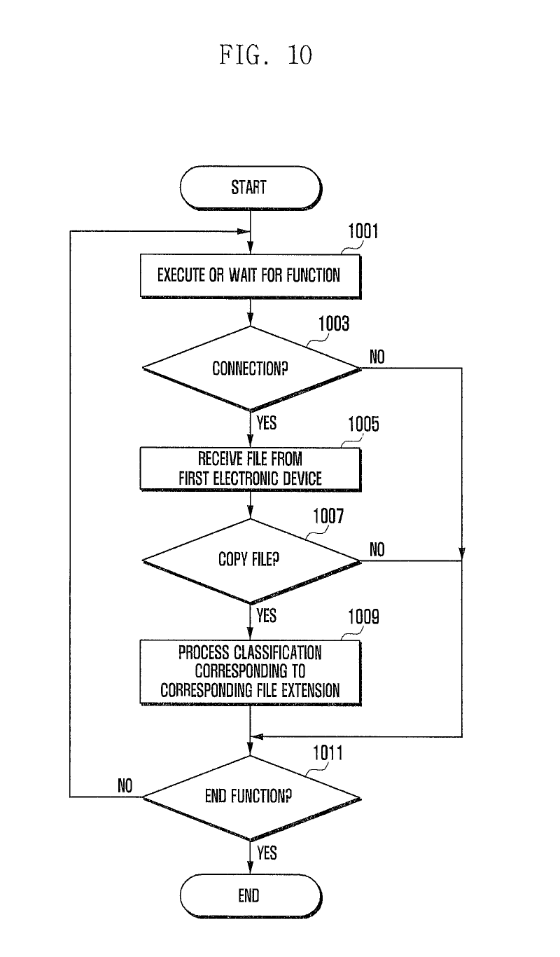

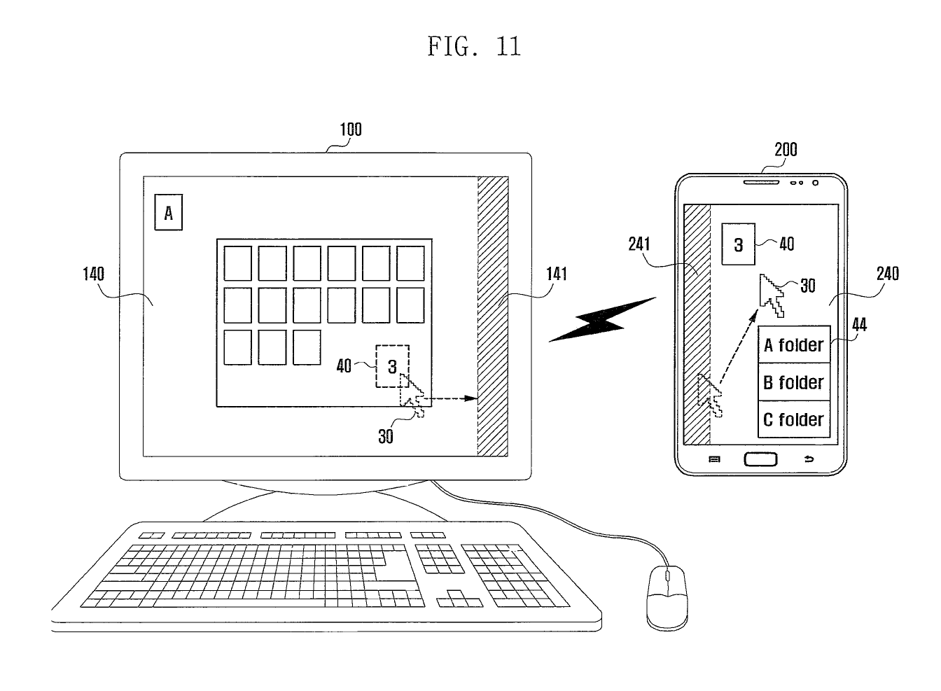

FIG. 10 is a flowchart illustrating an operation method of the second electronic device 200 for a file transmission related input control sharing function according to an embodiment of the present disclosure and FIG. 11 illustrates an example of a screen interface which can be applied to a file transmission related device operating system.

Referring first to FIG. 10, the second electronic device 200 can execute or wait for the function in step 1001. The second electronic device 200 can identify whether a connection request for sharing the input control is made in step 1003. The connection request can be received from the first electronic device 100. Alternatively, the connection request can be made through an input control of the second electronic device 200. When the connection request is made, the second electronic device 200 can form a communication channel with the first electronic device 100 and activate an App for supporting the input control sharing function.

When the connection for sharing the input control is made in step 1003, the second electronic device 200 can receive a file from the first electronic device 100 according to an operation of the connected first electronic device 100 in step 1005. To this end, the user can perform a device control for transmitting a file stored in or received by the first electronic device 100 to the second electronic device 200. For example, the first electronic device 100 can identify a content list, designate a particular content, and perform a control for transmitting the content to the second electronic device 200. In transmission of the file, some information can be transmitted. That is, only an icon image of the file or title information of the file can be transmitted to the second electronic device 200. The second electronic device 200 can configure and display the received information as an image or a text.

When the file is transmitted from the first electronic device 100, the second electronic device 200 can identify whether a request for copying the file is made in step 1007. That is, the second electronic device 200 can identify whether there is an input signal for copying the file in the input signals provided by the main input unit 120 included in the first electronic device 100.

When there is the input signal for copying the file, the second electronic device 200 can identify an extension of the copy request file and process classification according to the extension in step 1009. For example, the second electronic device 200 can identify a type of file through the file extension. Further, the second electronic device 200 can provide a list 44 of one or more folders which can be stored according to a type of file. To this end, the second electronic device 200 can predefine characteristics of the folders. For example, a particular folder can be defined as a folder storing a music file. A particular folder can be defined as a folder storing an image file. A particular folder can be defined as a folder storing a text file. A particular folder can be defined as a folder storing a dynamic image file. A particular folder can be defined as a folder storing information generated according to an execution of a particular App. The second electronic device 200 can output the folder list 44 while a file icon or a file image is displayed on the display device 240 according to the file transmission. When a file copy request is made, the second electronic device 200 can receive actual file information from the first electronic device 100. When the file copy request is made by the main input unit 120, the first electronic device 100 can transmit whole file information to the second electronic device 200. Alternatively, the first electronic device 100 can transmit the whole file information to the second electronic device 200 at a time when a file transmission request is made.

Next, the second electronic device 200 can identify whether an event for ending the function is generated in step 1011. When the event for ending the function is not generated, the second electronic device 200 can proceed to step 1001 to re-perform the following steps. When the event for ending the function is generated, the second electronic device 200 can control to end the input control sharing function.

Through a screen interface supporting the file transmission related input control sharing function in FIG. 11, the first electronic device 100 and the second electronic device 200 can configure the first transfer area 141 and the second transfer area 241 in the display unit 140 and the display device 240, respectively, when a connection for sharing the input control is made. The first transfer area 141 and the second transfer area 241 can be displayed to be distinguished from other areas. Alternatively, a separate display for distinguishing areas may not be applied.

The first electronic device 100 can display particular contents on the display unit 140 according to a user's control. At this time, when the user generates a transmission request for transmitting a first content 40 to the second electronic device 200 by using the main input unit 120, the first electronic device 100 can transmit the first content 40 to the second electronic device 200. For example, the user can move the first content 40 to the first transfer area 141 by selecting the first content 40 by using the mouse pointer 30 and then dragging the first content 40.

When the first content 40 and the mouse pointer 30 enter the first transfer area 141, the first electronic device 100 can recognize it as a request for transferring the input control authority and a request for transmitting the first content 40. Then, the first electronic device 100 can transmit the input control authority and the first content 40 to the second electronic device 200 and the second electronic device 200 can support to display the received input control authority and an image corresponding to the first content 40 on the second transfer area 241. At this time, the first electronic device 100 can transmit only some information such as an icon image or title information of the first content 40 to the second electronic device 200.

The second electronic device 200 can output the mouse pointer 30 according to reception of the input control authority and information related to the mouse pointer 30. Further, the second electronic device 200 can output the image related to the first content 14 or the title information received together with the input control authority on the display device 240. Particularly, the second electronic device 200 can identify extension information of the first content 40 and output the predefined folder list 44 which can be stored by the corresponding extension. The folder list 44 can be displayed together with the transmission of the first content 40. Alternatively, the folder list 44 can be output when a particular input signal for a copy request is generated.

The user can select a particular item from the folder list 44. Then, the first content 40 can be stored in the corresponding item. At this time, the first electronic device 100 can transmit whole actual file information to the second electronic device 200. The second electronic device 200 can store the received file in a corresponding file. Items displayed on the folder list 44 can be virtual information of actual folders. Accordingly, when the item is designated, the second electronic device 200 can identify an address where the corresponding item is actually located and control to include the transmitted file in the item.

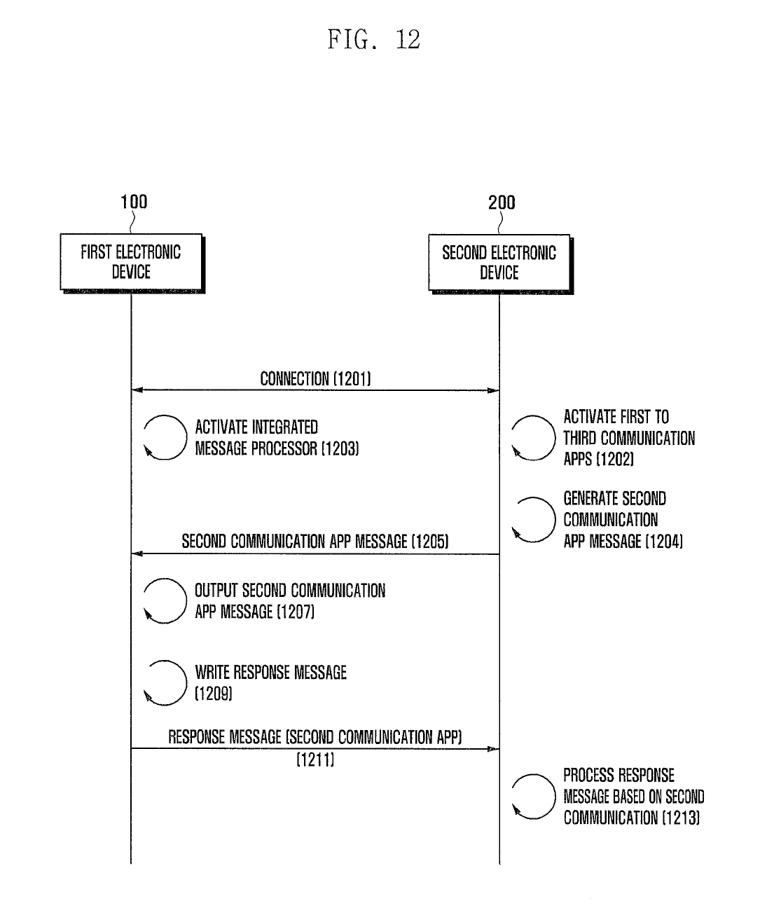

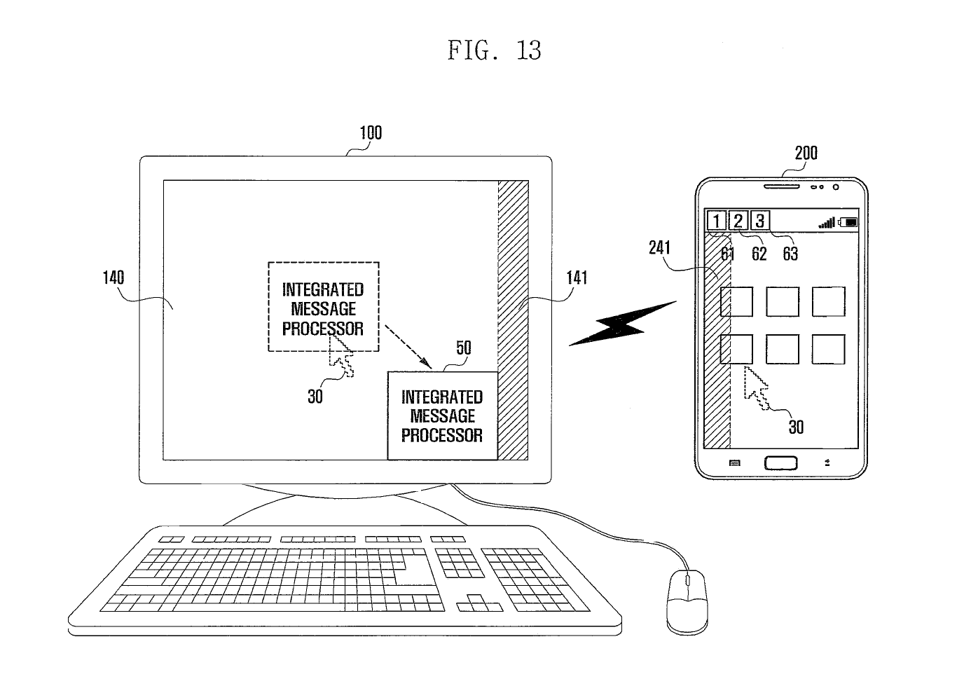

FIG. 12 is a signal flow diagram of the device operating system supporting a message related input control sharing function according to an embodiment of the present disclosure and FIG. 13 illustrates an example of the a screen interface supporting the message related input control sharing function.

Referring to FIG. 12, in the device operating system, the first electronic device 100 and the second electronic device 200 can make a connection for sharing the input control in step 1210.

The second electronic device 200 can activate first to third communication Apps in step 1202. The communication App can support a message function performed based on a message related program installed in the second electronic device 200. For example, the communication App can include various Apps, such as a chatting App, a short text message transmission/reception App, and a multimedia message transmission/reception App. The first to third communication Apps can be Apps distinguished by installations of different programs. Meanwhile, the second electronic device 200 can perform step 1201 in a state where the first to third communication Apps are activated. That is, the input control sharing function according to the present disclosure can be performed in a state where the communication App is first executed.

The first electronic device 100 can activate an integrated message processor in step 1203. To this end, the first electronic device 100 can provide a menu for integrated message processing. Further, when the menu for the integrated message processing is selected, the first electronic device 100 can control to activate the integrated message processing. Alternatively, when the connection for sharing the input control with the second electronic device 200 is made, the first electronic device 100 can control to automatically activate the integrated message processor. Alternatively, when the second electronic device 200 having the connection for sharing the input control is executing at least one communication App or generates an event for executing the communication App, the first electronic device 100 can control to automatically activate the integrated message processor.

Next, a message can be generated in at least one of the first to third communication Apps which are being executed in the second electronic device 200, for example, the second communication App in step 1204. Then, the second electronic device 200 can transmit the second communication App message to the first electronic device 100 in step 1205. At this time, the second electronic device 200 can transmit identification information of the communication App and message related information to the first electronic device 100 together with the content of the received message.

The first electronic device 100 can output the received second communication App message on the display unit 140 in step 1207. At this time, the first electronic device 100 can re-configure and output the second communication App message. For example, the first electronic device 100 can output the content of a message, sender information, second communication App type information, and message reception time information in such a manner that information is distinguished from each other.

Next, the first electronic device 100 can write a response message according to a user's control in step 1209. To this end, the first electronic device 100 can operate a message writing window of the integrated message processor. Further, the first electronic device 100 can generate a message according to an input signal input in the main input unit 120 by using the message writing window.

The first electronic device 100 can transmit the written response message to the second electronic device 200 in step 1211. At this time, the first electronic device 100 can insert second communication App related identification information into the response message to identify that the response message is for the second communication App and transmit the response to the second electronic device 200.

The second electronic device 200 can process the response message based on the second communication in step 1213. That is, when the second electronic device 200 receives the response message from the first electronic device 100, the second electronic device 200 can parse the content of the corresponding message to identify a type of communication App. Further, the second electronic device 200 can identify sender information to determine which user of which communication App to transmit a message to. The second electronic device 200 can parse content of the message, write the message in a message writing area of the second communication App, and control to transmit the message.

FIG. 13 illustrates an example of a screen interface which can be applied to a message related input control function according to the present disclosure.

Referring to FIG. 13, in the device operating system according to the present disclosure, the first electronic device 100 and the second electronic device 200 can have a connected state to support the input control sharing function. The second electronic device 200 can execute at least one communication App before the connection or activate the App after the connection. When the connection for sharing the input control is made, the first electronic device 100 and the second electronic device 200 can allocate the first transfer area 141 and the second transfer area 241.

Meanwhile, the first electronic device 100 can activate an integrated message processor 50 and display the integrated message processor 50 on the display unit 140 according to a user's request or an execution of the communication App of the second electronic device 200. For example, when the connection for sharing the input control with the second electronic device 200 is made, the first electronic device 100 can activate the integrated message processor 50 by default and display the integrated message processor 50 on the display unit 140. Alternatively, when the first electronic device 100 receives a communication App message from the second electronic device 200, the first electronic device 100 can activate the integrated message processor 50.

When the first electronic device 100 receives the communication App message from the second electronic device 200 after activating the integrated message processor, the first electronic device 100 can output the integrated message processor 50 including the content of the message on the display unit 140. Alternatively, the first electronic device 100 can output the integrated message processor 50 on one side of the display unit 140 and output the message through the integrated message processor 50 when the message is received.

When a response message is written through the integrated message processor 50 and an event for selecting the integrated message processor 50 to move to the first transfer area 141 is generated, the first electronic device 100 can determine that an event for transmitting the response message is generated. Then, the first electronic device 100 can transmit the input control authority and the response message to the second electronic device 200.

The second electronic device 200 can allocate the second transfer area 241 according to the connection for sharing the input control. Meanwhile, the second electronic device 200 can execute one or more communication Apps independently from sharing the input control, for example, first to third communication Apps 61, 62, and 63. The second electronic device 200 can output information notifying of executions of the communication Apps 61, 62, and 63 on a predetermined area of the display device 240. Alternatively, the second electronic device 200 can support the executions of the communication Apps 61, 62, and 63 based on background processing. In this case, outputting notification information before occurrence of the event related to the corresponding communication App can be prevented. Although FIG. 13 illustrates icons or indicators corresponding to the communication Apps 61, 62, and 63 in a status area to notify of the executions of the communication Apps 61, 62, and 63, the present disclosure is not limited thereto. That is, the electronic device can be designed such that the indicators are not separately displayed and an indicator informing of reception of a message related to the corresponding communication App is displayed when the message is received.

When a message related to a particular communication App is received, the second electronic device 200 can transmit a message including identification information of the corresponding communication App, message content, and message sender information to the first electronic device 100. Further, the second electronic device 200 can receive a response message including the message content, the communication App identification information, and the sender information from the first electronic device 100. Then, the second electronic device 200 can control to respond to a sender through the corresponding communication App by parsing the message content, the communication App identification information, and the sender information from the received response message. At this time, the second electronic device 200 can output a confirmation popup for transmitting the response message. Then, the user can make a request for transmitting the response message by selecting the confirmation by using the mouse pointer 30 transmitted through the first transfer area 141.

Through the above described method, the first electronic device 100 can write the response message of communication Apps being executed in the second electronic device 200 and the first electronic device 100 can automatically transmit the written response message or transmit the written response message through a confirmation process using the main input unit 120. Accordingly, the technology according to the present disclosure can guarantee continuity of operations using the main input units 120.

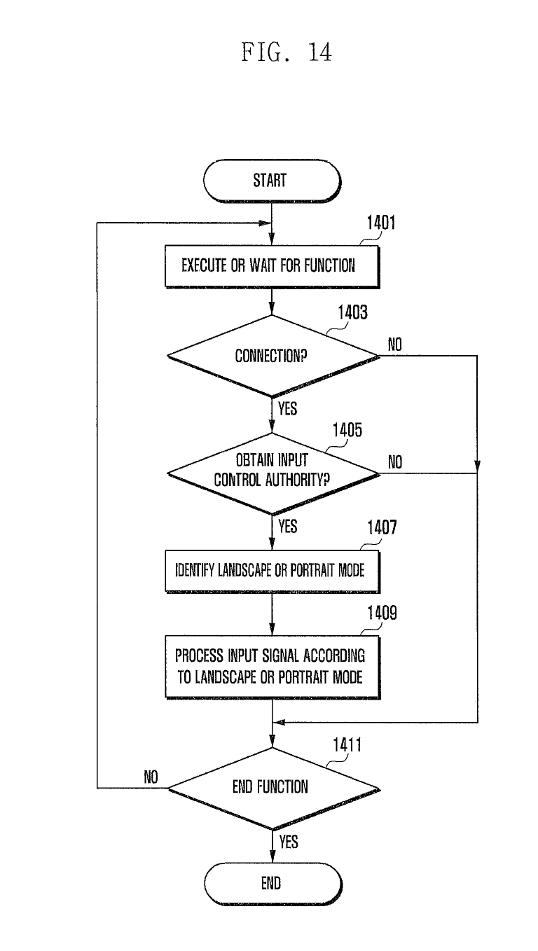

FIG. 14 is a flowchart illustrating an operation method of the second electronic device for processing a direction in the input control sharing function according to an embodiment of the present disclosure.

Referring first to FIG. 14, the second electronic device 200 according to the present disclosure can execute or wait for the function in step 1401. The second electronic device 200 can identify whether a connection request is made in step 1403. That is, the second electronic device 200 can identify whether a request for forming a communication channel for sharing an input control with the first electronic device 100 is made. When the connection request is made, the second electronic device 200 can form the communication channel for sharing the input control with the first electronic device 100 by using at least one of wired and wireless schemes. The communication channel for sharing the input control can be used as a path for transferring the input control authority and transmitting the input signal. Further, the communication channel can be used as a transmission path of information configured in the above described various embodiments.

When the connection request is made in step 1403, the second electronic device 200 can identify whether the input control authority is obtained in step 1405. The input control authority can be provided from the first electronic device 100 connected for the input control sharing function. To this end, the user can control the first electronic device 100 to transfer the input right control. When the input control authority is transferred, the second electronic device 200 can receive the input signal generated in the main input unit 120 of the first electronic device 100 from the first electronic device 100.

When the second electronic device 100 obtains the input right control in step 1405, the second electronic device 200 can identify a landscape mode or a portrait mode in step 1407. Alternatively, when the second electronic device 200 receives the input signal generated in the main input unit 120 after obtaining the input right control, the second electronic device 200 can identify a landscape or portrait layout state of the device. To this end, the second electronic device 200 can include an acceleration sensor or geomagnetic sensor and determine a posture based on a sensor signal collected by the sensor.

The second electronic device 200 can process the input signal according to the landscape or portrait mode in step 1409. That is, when the second electronic device 200 is arranged in the landscape mode, the second electronic device 200 can display an image or a text corresponding to the input signal provided by the first electronic device 100 to be appropriate for the landscape mode. Further, when the second electronic device 200 is arranged in the portrait mode, the second electronic device 200 can display an image or a text corresponding to the input signal provided by the first electronic device 100 to be appropriate for the portrait mode.

The second electronic device 200 can identify whether an event for ending the function is generated in step 1411 and return to step 1401 to re-perform the following steps. When there is no connection in step 1403 or the input control authority is not obtained in step 1406, the second electronic device 200 can proceed to step 1411 to re-perform the following steps.

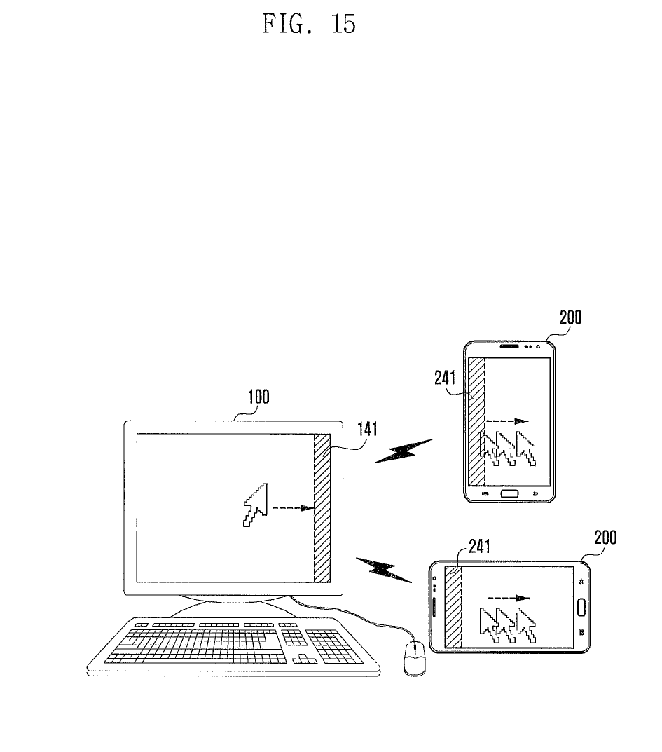

FIG. 15 illustrates an example of a screen interface supporting direction processing in the input control sharing function according to an embodiment of the present disclosure.

Referring to FIG. 15, the first electronic device 100 and the second electronic device 200 can have a connected state to support the input control sharing function. Then, the first electronic device 100 and the second electronic device 200 can allocate the first transfer area 141 and the second transfer area 241 to support the input control sharing function.

In the above described state, the first electronic device 100 can output the mouse pointer 30 on the display unit 140 according to a control of the mouse included in the main input unit 120. The first electronic device 100 can move the mouse pointer 30 to the first transfer area 141 by controlling the mouse. When the mouse pointer 30 enters the first transfer area 141, the first electronic device 100 can determine that an event for transferring the input control authority is generated. The input control authority can be transferred to the second electronic device 200. At this time, the first electronic device 100 transmit a movement signal according to the mouse control to the second electronic device 200 after the input control authority is transferred. Actually, since a mouse movement control is continuously generated, a mouse movement signal can be continuously generated after the mouse pointer 30 enters the first transfer area 141. Accordingly, the mouse movement signal can also be transmitted when the input control authority is transferred to the second electronic device 200. Further, the mouse movement signal can be continuously transmitted to the second electronic device 200.

The second electronic device 200 can control a display of the mouse pointer 30 when the input control authority is transferred. For example, the second electronic device 200 can output the mouse pointer 30 in a predetermined position of the second transfer area 241. Further, the second electronic device 200 can move and display the mouse pointer 30 on the display device 240 in accordance with the mouse movement signal.

When the input control sharing function with the first electronic device 100 is configured, the second electronic device 200 can allocate the second transfer area 241. At this time, when the second electronic device 200 is arranged in the portrait mode, the second transfer area 241 can be allocated to a predetermined left edge area of the device arranged in the portrait mode. When the second electronic device 200 is arranged in the landscape mode, the second transfer area 241 can be allocated to a predetermined left edge area of the device arranged in the landscape mode. When a direction of the device is switched from a vertical direction to a horizontal direction or from the horizontal direction to the vertical direction, the second electronic device 200 can change the second transfer area 241 according to the direction switching. Meanwhile, although an example of allocating the second transfer area 241 to the left edge area has been described, the present disclosure is not limited thereto. That is, the second transfer area 241 can be allocated to a right edge area according to a change of a user's setting or a design intention. Alternatively, the second transfer area 241 can be allocated to an upper or lower edge area. Further, when the landscape or portrait mode is change, the allocation position of the second transfer area 241 can be changed according to the mode change.

As a result, regardless of the portrait mode or the landscape mode of the second electronic device 200, the mouse pointer 30 can be displayed in a direction continuous to a direction in which the mouse pointer 30 has moved on the display unit 140 of the first electronic device 100. For example, when the mouse pointer 30 moves from a left side to a right side on the first electronic device 100 and thus enters the first transfer area 141 allocated to the right edge of the display unit 140, the mouse pointer 30 can be displayed on the second transfer area 241 in the left edge of the display device 240 of the second electronic device 200 and then move in a right direction and displayed.

In contrast, when the mouse pointer 30 moves from a right side to a left side on the second electronic device 200 and thus enters the second transfer area 241 allocated to the left edge of the display device 240, the mouse pointer 30 can be displayed on the first transfer area 141 in the right edge of the display unit 140 of the first electronic device 100 and then move in a left direction and displayed. In such a process, the mouse can input a continuous movement in the left direction.

FIG. 14 has described that the process of identifying the landscape mode or the portrait mode of the second electronic device 200 is performed after the input control authority is transferred. However, the present disclosure is not limited thereto, and the second electronic device 200 can identify in advance the landscape mode or the portrait mode according to a current state and accordingly allocate the second transfer area 241 according to the identified mode as illustrated in FIG. 15. As a result, in outputting the mouse pointer 30, the second electronic device 200 displays a movement of the mouse pointer 30, starting from the second transfer area 241, and thus provides a continuous movement display from the mouse pointer 30 of the first electronic device 100. The first transfer area 141 and the second transfer area 241 can be located at the display unit 140 and the display device 240 which are close to each other to display such a continuous movement. Alternatively, positions of the first transfer area 141 and the second transfer area 241 can be changed to be placed close to each other according to a user's control.

The second electronic device 200 can limit a movable area of the mouse pointer 30 to a size of the display device 240 in the process of allocating the second transfer area 241. That is, in other edges except for the edge of the display device 240 where the second transfer area 241 is located, the second electronic device 200 can process such that the mouse pointer 30 does not escape from the corresponding edge.

Meanwhile, although the change of the second transfer area 241 and the movement of the mouse pointer 30 according to the landscape or portrait layout of the second electronic device 200 have been described, the device operating system according to the present disclosure can support a screen change through synchronization between the first electronic device 100 and the second electronic device 200. That is, when there is the connection for the input control mode function in a state where the second electronic device 200 is arranged in the landscape mode, the first electronic device 100 can support the screen change according to the landscape mode arrangement of the second electronic device 200. At this time, the screen output on the first electronic device 100 can be the same as the screen displayed on the second electronic device 200 as described above or can be different from the screen displayed on the second electronic device 200. When the same screen is displayed according to screen sharing, the first electronic device 100 can control a screen layout of the display unit 140 to be different according to a screen layout of the second electronic device 200. More specifically, when the second electronic device 200 is arranged in the landscape mode, the first electronic device 100 can control a ratio of the screen of the display unit 140 to be appropriate for the landscape mode and display the screen. When the second electronic device 200 is changed from the landscape mode to the portrait mode, the first electronic device 100 can control a ratio of the screen of the display unit 140 to be appropriate for the portrait mode and display the screen. As a result, the first electronic device 100 can output the screen arranged in the same direction as that of the screen output on the display device 240 of the second electronic device 200.

Meanwhile, when the input control sharing function is executed in a state where each of the electronic devices outputs the screen according to App execution without the screen sharing, the first electronic device 100 can receive only a landscape or portrait layout element of the second electronic device 200 and control to change the screen output on the display unit 140 in accordance with the corresponding element. Accordingly, the first electronic device 100 displays the screen different from the screen of the second electronic device 200 but can display the same display direction as the display direction of the second electronic device 200.

As described above, the input control sharing function according to the embodiment of the present disclosure can support input control of a plurality of devices by using one input device or an input device connected to one device through an easier input control between devices sharing a main input unit.

Meanwhile, at least one of the first electronic device 100 and the second electronic device 200 can further include various additional modules according to a provided type thereof. That is, when at least one of the first electronic device 100 and the second electronic device 200 is a communication terminal, at least one of the first electronic device 100 and the second electronic device 200 can further include components for supporting various functions, such as an Internet communication module communicating with an Internet network to perform an Internet function and a digital broadcasting module performing a function of receiving and reproducing a digital broadcast. Although all such elements may not be enumerated since modifications thereof can be diversely made according to a convergence trend of digital devices, elements equivalent to the aforementioned elements can be further included in the devices. This will be easily understood by those skilled in the art to which the present disclosure pertains.

Further, at least one of the APP operating device 100 and the APP output device 200 according to the embodiment of the present disclosure can include, for example, all data communication devices, multimedia devices and applications thereof, such as a Portable Multimedia Player (PMP), a digital broadcasting player, a Personal Digital Assistant (PDA), a music player (e.g., an MP3 Player), a portable game terminal, a smart phone, a notebook computer, a handheld PC and the like as well as all mobile communication terminals operating based on communication protocols corresponding to various communication systems.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method of controlling an input in a first electronic device, the method comprising:
connecting the first electronic device to a second electronic device;
determining whether a transfer event occures on a first transfer area of a screen of the first device;
transferring an input control authority of the first electronic device to the second electronic device in response to the occurrence of the transfer event; and
recovering the input control authority of the first electronic device from the second electronic device in response to an occurrence of a transfer event on a second transfer area of a screen of the second device.

2. The method of claim 1, wherein the second transfer areas is allocated in a different position according to a landscape direction layout or a portrait direction layout of the screen of the second electronic device.

3. The method of claim 1, further comprising:
displaying a input point on the first electronic device;
upon entering the input point into the first transfer area, removing a pointer indicating the input point from the first transfer area and displaying the pointer on the second transfer area.

4. The method of claim 2, wherein allocating the first transfer area comprises allocating a plurality of first transfer areas according to a number of connected electronic devices.

5. The method of claim 2, wherein allocating the first transfer area comprises allocating a particular edge area of an edge area of the display unit as the first transfer area according to a user's control.

6. The method of claim 1, further comprising:
copying at least a part of contents and storing the part of the contents in a clipboard by the first electronic device; and
transmitting the contents of clipboard to the second electronic device when the input control authority is transferred.

7. The method of claim 6, further comprising:
displaying content related information included in the clipboard in a form of a list.

8. The method of claim 1, further comprising:
selecting a file displayed on the first electronic device based on input point;
detecting the input point entering into the first transfer area in a state where a selection of the file is maintained;
transmitting the selected file to the second electronic device; and
displaying an image related to the file and the pointer in the second transfer area by the second electronic device.

9. The method of claim 8, further comprising:
identifying an extension of the file; and
outputting a folder list including one or more folder items which can be stored based on the extension of the file.

10. The method of claim 1, further comprising:
executing one or more communication Apps in the second electronic device;
receiving a message in the communication App being executed;
transmitting the received message, type information of the communication App, and sender information to the first electronic device;
outputting the message to the first electronic device;
transmitting a response message of the message written according to an input signal to the second electronic device together with the type information of the communication App and the sender information by the first electronic device; and
transmitting the response message to a device corresponding to the sender information by the second electronic device.

11. An electronic device for performing an input control, the electronic device comprising:
a communication interface configured to connect with an external device to share an input control;
a controller configured to:
determine whether a transfer event occures on a first transfer area of a first screen of the electronic device;
transfer an input control authority of the electronic device to the external device in response to the occurrence of the transfer event; and
recover the input control authority of the electronic device from the external device in response to an occurrence of a transfer event on a second transfer area of a second screen of the external device.

12. The electronic device of claim 11, wherein the input receiver includes at least one of a keyboard, a mouse, an input pad, and a voice input unit which generate a key input signal.

13. The electronic device of claim 12, wherein the controller is configured to transfer the input control authority to the external device when a input point enters the first transfer area.

14. The electronic device of claim 11, wherein the controller is configured to remove the pointer from the first screen.

15. The electronic device of claim 11, wherein, when a message according to an execution of a communication App in a particular type is received from the external device, the controller is configured to control to output the received message and transmit a response message received from an input signal to the external device together with type information of the communication App and sender information of the message.

16. The electronic device of claim 11, wherein at least one of the image data and the file data is transferred with the input control authority.

17. The electronic device of claim 16, wherein, when the file is received from the external device, the controller is configured to identify an extension of the file and control to output a folder list including one or more folder items to be stored based on the extension of the file.

18. The electronic device of claim 16, when a clipboard is received from the external device, the controller is configured to control to output a list of one or more contents stored in the clipboard.

19. The electronic device of claim 16, wherein, when a message is received in one or more communication Apps being executed, the controller is configured to control to transmit content of the message, sender information of the message, and type information of the communication App to the another device and controls to transmit a response message through the corresponding communication App by parsing content of the message, sender information, and communication App type information from the response message received from the another device.

20. The electronic device of claim 16, wherein the controller is configured to identify a landscape mode layout, a portrait mode layout, or a landscape/portrait mode change, and control a display position of the transfer area.
